(19) United States
(12) Patent Application Publication
(10) Pub. No.: US 2025/0021753 A1
(43) Pub. Date: Jan. 16, 2025

(54) SELECTIVE MEMORY RETRIEVAL FOR THE GENERATION OF PROMPTS FOR A GENERATIVE MODEL

(71) Applicant: Microsoft Technology Licensing, LLC, Redmond, WA (US)

(72) Inventors: Brian Scott KRABACH, Snohomish, WA (US); Samuel Edward SCHILLACE, Portola Valley, CA (US); Umesh MADAN, Bellevue, WA (US); John MAEDA, Redmond, WA (US)

(73) Assignee: Microsoft Technology Licensing, LLC, Redmond, WA (US)

(21) Appl. No.: 18/486,075

(22) Filed: Oct. 12, 2023

Related U.S. Application Data
(60) Provisional application No. 63/513,696, filed on Jul. 14, 2023.
(60) Provisional application No. 63/514,776, filed on Jul. 20, 2023.

(51) Int. Cl. G06F 40/20

(52) U.S. Cl. CPC G06F 40/20

(57) ABSTRACT

A computing system is provided for selective memory retrieval. The computing system includes processing circuitry configured to provide access to a plurality of memory banks, cause an interaction interface for a trained generative model to be presented, receive, via the interaction interface, an instruction from the user for the trained generative model to generate an output, extract a context of the instruction, generate a memory request including the context and the instruction, input the memory request into a plurality of memory retrieval agents respectively coupled to the plurality of memory banks to retrieve a plurality of relevant memories, generate a prompt based on the retrieved relevant memories and the instruction from the user, provide the prompt to the trained generative model, receive, in response to the prompt, a response from the trained generative model, and output the response to the user.

### CROSS REFERENCE TO RELATED APPLICATIONS

This application claims priority to U.S. Provisional Patent Application No. 63/513,696, filed Jul. 14, 2023, and to U.S. Provisional Patent Application No. 63/514,776, filed Jul. 20, 2023, the entirety of each of which is hereby incorporated herein by reference for all purposes.

### BACKGROUND

The advent of generative models, especially large language models, has significantly advanced human-computer interactions. These models are trained on extensive data sets that enable them to generate text which can be coherent, contextually relevant, and insightful. Users often interact with these generative models through various platforms, inputting inquiries, asking questions, or seeking advice on a wide range of topics. Such interactions can span simple queries like asking for the weather forecast to complex discussions about philosophy, technology, and beyond.

To improve the user experience and offer more personalized responses, the user's interaction history with the generative model may be stored in memory banks. These “memories” may encompass all the data points generated during the interactions, which may include but are not limited to the queries posed by the user, the responses generated by the model, and any feedback or supplementary information provided by the user.

However, a persistent challenge in the utilization of these memory banks is the selective retrieval of relevant memories to appropriately address a user's current questions or inquiries. As a user interacts more frequently with the system, the memory bank becomes increasingly populated with data. Without an effective mechanism to selectively retrieve and utilize these memories, the system faces difficulties in providing contextually relevant and personalized responses.

For instance, if a user has had multiple discussions about various genres of music but is currently asking specifically about jazz music, a simple retrieval mechanism might struggle to filter out irrelevant conversations about rock, classical, or electronic music. The result could be a less-than-optimal user experience, with answers that lack the nuanced understanding that could be achieved through the effective use of past interaction data.

### SUMMARY

To address the above issues, a computing system is provided for selective memory retrieval. The computing system includes processing circuitry configured to provide access to a plurality of memory banks, each storing a plurality of memories, cause an interaction interface for a trained generative model to be presented, receive, via the interaction interface, an instruction from the user for the trained generative model to generate an output, extract a context of the instruction, generate a memory request including the context and the instruction, input the memory request into a plurality of memory retrieval agents respectively coupled to the plurality of memory banks to retrieve a plurality of relevant memories among the plurality of memories, generate a prompt based on the retrieved relevant memories and the instruction from the user, provide the prompt to the trained generative model, receive, in response to the prompt, a response from the trained generative model, and output the response to the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a schematic view showing a computing system according to a first example implementation.

FIG. 2 is a schematic view showing a computing system according to a second example implementation.

FIG. 3 is a schematic view showing inputs and outputs of the memory request router of FIG. 1 or FIG. 2 according to an example implementation.

FIG. 4 is a schematic view showing an input and an output of the generative model of FIG. 1 or FIG. 2 according to an example implementation.

FIG. 5 shows a flowchart for a first method for selective memory retrieval according to one example implementation.

FIG. 6 shows a flowchart for a second method for selective memory retrieval according to one example implementation.

FIG. 7 shows a schematic view of an example computing environment in which the computing system of FIG. 1 or 2 may be enacted.

### DETAILED DESCRIPTION

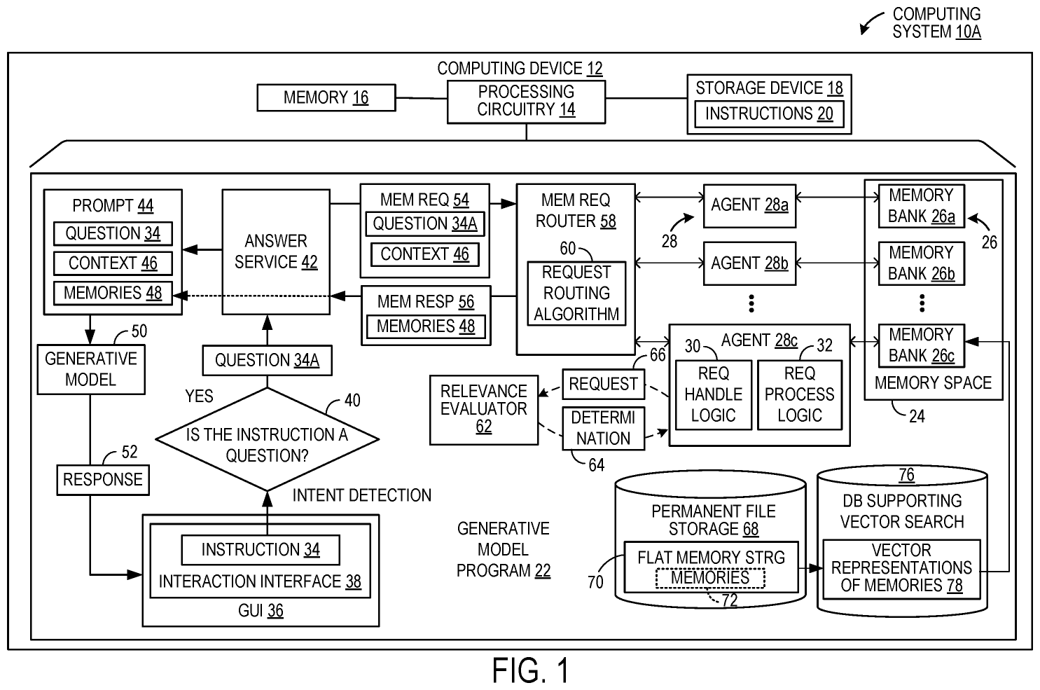

To address the issues described above, FIG. 1 illustrates a schematic view of a computing system 10A for selective memory retrieval, according to a first example implementation. For the sake of clarity, the trained generative model 50 will be henceforth referred to as a trained generative language model 50. However, it will be noted that the term ‘trained generative language model’ is merely illustrative, and the underlying concepts encompass a broader range of generative models, including multi-modal models, diffusion models, and generative adversarial networks, which may receive text, image, and/or audio inputs and generate text, image, and/or audio outputs, as discussed in further detail below.

The computing system 10A includes a computing device 12 having processing circuitry 14, memory 16, and a storage device 18 storing instructions 20. In this first example implementation, the computing system 10A takes the form of a single computing device 12 storing instructions 20 in the storage device 18. The instructions 20 include a generative model program 22. When the generative model program 22 is executed by the processing circuitry 14, various functions are performed. These functions include providing access to a plurality of memory banks 26 in a memory space 24, where each memory bank 26 includes a plurality of memories 72.

The memories 72 are first generated by a trained memory-extracting generative model based on user interactions with the computing system 10A, and then organized in memory banks 26 by a plurality of memory retrieval agents 28. The memories 72 can be generated by being extracted from a user interaction history between the user and the computing system 10A using the trained memory-extracting generative model. For example, user interaction history can include user interactions with the computing system 10A via modalities including files, chat messages, email messages, calendar information, search and browsing activity, social media activity, gaming activity, and user state. In one specific implementation, this information may be stored in a graph database that can be queried to identify relevant information in the user interaction history to a memory extraction query. The generated memories include natural language text descriptions of the interactions in the user interaction history that have been generated by the trained memory-extracting generative model. The trained memory extracting generative model can be generative language model 50 or another generative model. These memories 72 are stored in file storage 68 in text form, and embedding (vector) representations 78 of the memories 72 are stored in an associated database 76 with a vector search interface. In this way, the memories 72 may summarize information from a variety of sources such as emails, calendar entries, chat messages, files, etc. Once the memories 72 are stored and made searchable, the memory retrieval agents 28 searches for memories of relevance to each agent 28, using the vector search interface, and loads matching memories into memory banks 26 in memory space 24. In one implementation, each memory retrieval agent 28 is assigned a particular topic or role using a textual description of that topic or role and ranking or clustering algorithms may be used to identify memories related to the particular topic or role. In this way, each agent may pre-load a subset of the memories 72 into its associated memory bank 26. These pre-loaded memory banks 26 are then used by each memory retrieval agent 28 to search for memories relevant to incoming memory requests 54 from the answer service 42, as described below.

The program 22 also causes an interaction interface 38 for a trained generative model 50 to be presented. Through the interaction interface 38, an instruction 34 from the user is received for the trained generative model 50 to generate an output. The program 22 then extracts a context 46 of the instruction 34 and generates a memory request 54 including the context 46 and the instruction 34. The memory request 54 is inputted into a plurality of memory retrieval agents 28 respectively coupled to the plurality of memory banks 26 to retrieve a plurality of relevant memories 48 among the plurality of memories 72. The program 22 then generates a prompt 44 based on the retrieved relevant memories 48 and the instruction 34 from the user. The prompt 44 is provided to the trained generative model 50, which generates a response 52 in response to the prompt 44. The response 52 is received from the trained generative model 50 and subsequently outputted to the user. It will be appreciated that instruction 34 is natural language text, typically input by a user, and response 52 also includes natural language text generated by the trained generative model.

The processing circuitry 14 is configured to cause an interaction interface 38 for the trained generative language model 50 to be presented. In some instances, the interaction interface 38 may be a portion of a graphical user interface (GUI) 36 for accepting user input and presenting information to a user. Both the response 52 and instruction 34 are typically displayed in the interaction interface along with the instruction 34. In one example, they may be displayed in a turn-based chat interface. In other instances, the interaction interface 38 may be presented in non-visual formats such as an audio interface for receiving and/or outputting audio, such as may be used with a digital assistant. In yet another example the interaction interface 38 may be implemented as an interaction interface application programming interface (API). In such a configuration, the input to the interaction interface 38 may be made by an API call from a calling software program to the interaction interface API, and output may be returned in an API response from the interaction interface API to the calling software program. It will be understood that distributed processing strategies may be implemented to execute the software described herein, and the processing circuitry 14 therefore may include multiple processing devices, such as cores of a central processing unit, co-processors, graphics processing units, field programmable gate arrays (FPGA) accelerators, tensor processing units, etc., and these multiple processing devices may be positioned within one or more computing devices, and may be connected by an interconnect (when within the same device) or via a packet switched network links (when in multiple computing devices), for example. Thus, the processing circuitry 14 may be configured to execute the interaction interface API (e.g., interaction interface 38) for the trained generative model 50, so that the processing circuitry 14 is configured to interface with the trained generative model 50 that receives input of the prompt 44 including natural language text input and, in response, generates a response 52 that includes natural language text output.

In general, the processing circuitry 14 may be configured to receive, via the interaction interface 38 (in some implementations, the interaction interface API), natural language text input as instruction 34, which is incorporated into a prompt 44. The answer service 42 generates the prompt 44 based at least on natural language text input from the user. The prompt 44 is provided to the trained generative model 50. The trained generative language model 50 receives the prompt 44, which includes the natural language text input as the instruction 34 from the user for the trained generative language model 50 to generate a response 52, and generates, in response to the prompt 44, the response 52 which is outputted to the user. It will be understood that the natural language text input may also be generated by and received from a software program, rather than directly from a human user. Instruction 34 may be natural language input that is in any suitable form, including a question, message, command, comment, etc.

The trained generative language model 50 is a generative model that has been configured through machine learning to receive input that includes natural language text and generate output that includes natural language text in response to the input. It will be appreciated that the trained generative language model 50 can be a large language model (LLM) having tens of millions to billions of parameters, non-limiting examples of which include GPT-3, BLOOM, and LLaMA-2. The trained generative language model 50 can be a multi-modal generative model configured to receive multi-modal input including natural language text input as a first mode of input and image, video, or audio as a second mode of input, and generate output including natural language text based on the multi-modal input. The output of the multi-modal model may additionally include a second mode of output such as image, video, or audio output. Non-limiting examples of multi-modal generative models include Kosmos-2 and GPT-4 VISUAL. Further, the trained generative language model 50 can be configured to have a generative pre-trained transformer architecture, examples of which are used in the GPT-3 and GPT-4 models.

The plurality of memories in the memory banks 26 may be used to extract high-dimensional vectors, also known as embeddings, which are vector representations 78 of the plurality of memories. Once generated, these vector representations 78 may be stored in a database 76 that supports vector search operations. The memory retrieval agents 28 may employ density-based clustering algorithms to organize these vector representations 78 into distinct clusters. The clustering may be based on the relative distances between the embeddings, which allows for effective grouping of similar or related memories into memory clusters.

These consolidated memory clusters may then be stored in the memory banks 26 for efficient retrieval. When a specific memory request 54 arrives, each memory retrieval agent 28 may scan its own set of memory banks 26. The memory retrieval agent 28 may then forwards the memory request 54 to a relevance evaluator 62, which determines whether any of the memories in the designated memory banks 26 of the memory retrieval agent 28 are pertinent to the incoming memory request 54. When the relevant evaluator 62 identifies relevant memories 48, these are then returned by the memory retrieval agent 28 to the memory request router 58. This approach may allow for a streamlined and accurate process for memory extraction and retrieval, ensuring that the computing system 10A can efficiently handle complex tasks involving data storage and user queries.

To retrieve the relevant memories 48, an interaction interface 38 is provided by which an instruction 34 can be received as user input. At decision point 40, the system 10A determines whether the instruction 34 is a question 34A, and if so then attempts to generate a response 52 to the question 34A using the generative model 50, calling an answer service 42 to generate a response 52. In some implementations if it is determined that the instruction 34 is not a question 34A, then the computing system rephrases the instruction 34 as a question, or requests the user to do so. When the system 10A determines that the instruction 34 contains a plurality of questions 34A, the instruction 34 may be divided into a plurality of subparts and each subpart may be responded to independently. In other implementations, the answer detection at decision point 40 may be omitted and the instruction 34 may be passed directly to the answer service 42 without checking whether the instruction 34 is in the form of a question.

The answer service 42 extracts a context 46 from the question 34A (or instruction 34), and generates a memory request 54 comprising the question 34A (or instruction 34) and the context 46. The answer service 42 inputs the memory request 54 into a memory request router 58 which is configured to route the memory request 54 to one of a plurality of memory retrieval agents 28a-c which are respectively coupled to a plurality of memory banks 26a-c. In FIG. 1, three memory retrieval agents 28a-c and three corresponding memory banks 26a-c are illustrated. However, the number of memory retrieval agents 28a-c and memory banks 26a-c is not particularly limited. The system 10A may accommodate fewer or more than three memory retrieval agents 28a-c, and an equivalent number of corresponding memory banks 26a-c may also be configured.

When the instruction 34 is divided into a plurality of subpart instructions at decision point 40, the plurality of subpart instructions may be incorporated into a plurality of memory requests 54, respectively, and inputted into the plurality of memory retrieval agents 28a-c.

The memory request router 58 may execute a request routing algorithm 60 to route the memory request 54 to the appropriate memory retrieval agent 28a-c, matching the context 46 of the memory request 54 to the subject of the memory retrieval agent 28a-c. The memory retrieval agent 28c receiving the memory request 54 executes request handling logic 30 to receive the memory request 54 and determine whether the memory request 54 can be handled by the memory retrieval agent 28c. Responsive to determining that the memory request 54 can be handled by the memory retrieval agent 28c, the memory retrieval agent 28c executes request processing logic 32 to process the memory request 54 and retrieve one or a plurality of relevant memories 48 from the memory bank 26c which match the context 46 of the memory request 54.

The memory banks 26 may be configured to operate similarly to or configured to be stored within database 76 and support vector search operations. These memory banks 26 may store both textual data for the memories 72 as well as embeddings or vector representations 78 of the memories 72 within the memory banks 26. As described above, embeddings or vector representations 78 of the plurality of memories 72 are stored in the database 76 supporting vector search during the memory generation process. The stored memories 72 may be housed in a flat memory storage structure 70, and may be part of a permanent file storage system 68. The embeddings or vector representations 78 are typically created during this memory generation process described above and stored in database 76; however, in other implementations the memory retrieval agents 28 may convert the textual memories 72 stored in file storage 68 into embeddings or vector representations 78 when loading them into memory banks 76. This process vectorizes sentences, phrases, or other linguistic constructs within the memories 72. These vector representations 78 may facilitate the rapid and efficient retrieval of relevant memories 48 based on their similarity to the context 46 indicated in the memory request 54.

The request processing logic 32 within a specific memory retrieval agent (for example, memory retrieval agent 28c) may compute distances between the vector representations 78 associated with the stored memories in the memory banks 26 and the vector representation of the context 46 of the memory request 54. The computations of distances may be performed using distance algorithms and formulas such as cosine similarity formula or the Euclidean distance formula. Once the distances are calculated, the request processing logic 32 may select the relevant memories 48 for retrieval based on a predetermined distance threshold. For example, only those memories with distances from the given context 46 that fall below the predetermined distance threshold may be retrieved as the relevant memories 48.

Once retrieved, the memory retrieval agent 28 (e.g., memory retrieval agent 28c) may further route retrieved memories 48 to a relevance evaluator 62, which is configured to assess the relevance of the retrieved memories 48 to the context 46 of the memory request 54. The relevance evaluator 62 may be configured as a generative model or a classifier.

Upon retrieving the relevant memories 48, the memory retrieval agent 28c forwards the relevant memories 48 to the relevance evaluator 62 in a relevance determination request 66. Using predefined algorithms or trained machine learning models, the relevance evaluator 62 assesses how relevant the retrieved relevant memories 48 are to the context 46 of the memory request 54, and subsequently generates a determination signal 64 indicating a relative relevance for each of the relevant memories 48.

This determination signal 64 is then sent to the request handling logic 30 within the memory retrieval agent 28c. Based on the received determination, the request handling logic 30 selectively filters the retrieved relevant memories 48 based on a relative relevance determined for each of the retrieved relevant memories 48. The selectively filtered relevant memories 48 are then outputted to the answer service 42.

After retrieving relevant memories 48 from the memory retrieval agents 28, the memory request router 58 generates a memory response 56 containing the relevant memories 48. The answer service 42 generates the prompt 44 based on the question 34 from the user, the context 46 extracted from the question 34, and the relevant memories 48 retrieved by the memory request router 58. The prompt 44 is inputted into the generative language model 50, which in turn generates the response 52 and returns the response 52 for display to the user via the interaction interface 38.

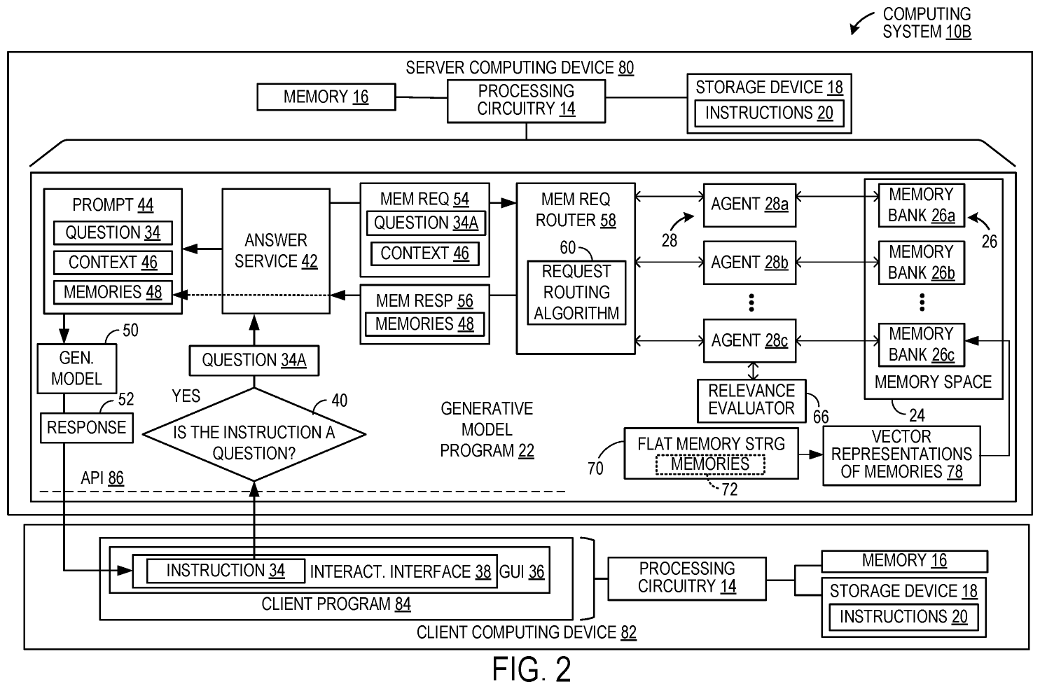

Turning to FIG. 2, a computing system 10B according to a second example implementation is illustrated, in which the computing system 10B includes a server computing device 80 and a client computing device 82. Here, both the server computing device 80 and the client computing device 82 may include respective processing circuitry 14, memory 16, and storage devices 18. Description of identical components to those in FIG. 1 will not be repeated. As shown in FIG. 2, the generative model 50 and the generative model program 22 can be executed on a different server 80 from the computing device 82 executing the interaction interface 38, and the client program 84 executed on the computing device 82 can send a request or instruction 34 to an API 86 of the generative model program 22 on the different server 80 across a computer network such as the Internet, and in turn receive a response, in some examples.

The client computing device 82 may be configured to present the interaction interface 38 as a result of executing a client program 84 by the processing circuitry 14 of the client computing device 82. The client computing device 82 may be responsible for communicating between the user operating the client computing device 82 and the server computing device 80 which executes the generative model program 22 and contains the memory request router 58, memory banks 26, respective memory retrieval agents 28, and the generative model 50, via an API 86 of the generative model program 22. The client computing device 82 may take the form of a personal computer, laptop, tablet, smartphone, smart speaker, etc. The same processes described above with reference to FIG. 1 may be performed, except in this case the natural language text input 34 and output 52 may be communicated between the server computing device 80 and the client computing device via a network such as the Internet.

Further, the generative language model 50 may be executed on a different server from the server computing device 80 depicted in FIG. 2. In such an embodiment, the server computing device 80 may invoke an API call to transmit a data request to a different external server executing the generative language model 50. Upon receipt of the data request, the external server may decode the incoming API call and extract input parameters, receiving input of the prompt including natural language text input. The API of the generative language model 50, acting as a gateway, may channel the input of the prompt into the generative language model 50 for processing. The generative language model 50, executed on the external server, may perform its operations and generate a response that includes natural text output. The response may be encapsulated by the API of the generative language model 50 and transmitted back to the server computing device 80, which receives, in response to the prompt, the response from the trained generative model 50, and output the response to the user.

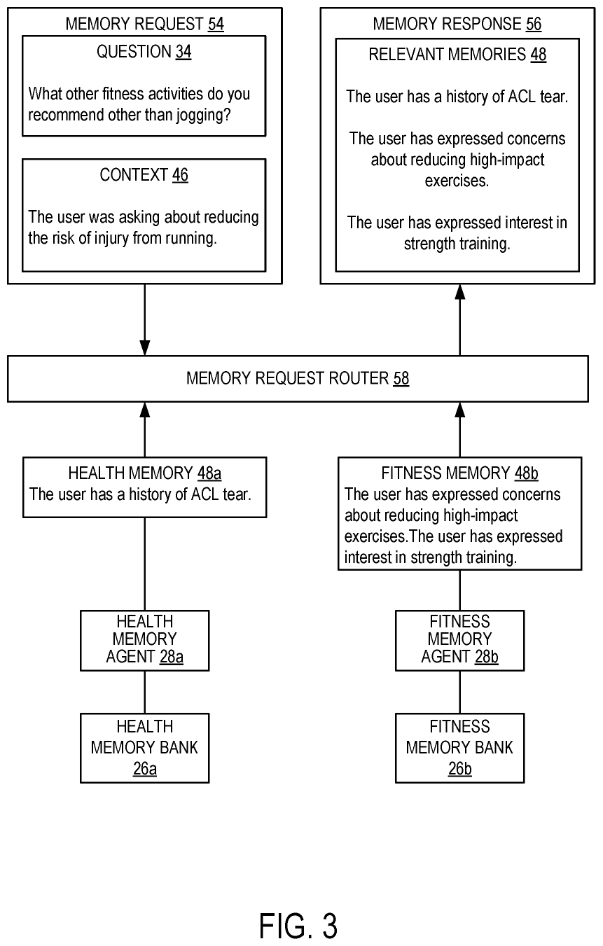

Turning to FIG. 3, an example is described of a memory request router 58 which receives a memory request 54 and outputs a memory response 56 including relevant memories 48 that are determined to be relevant to the memory request 54. In this example, the answer service generates a memory request 54 including a user's question 34, “What other fitness activities do you recommend other than jogging?” and an extracted context 46, which is determined to be “The user was asking about reducing the risk of injury from running”. The context 46 is extracted by analyzing the recent chat history of the user, and determining that the user expressed frequent concerns about reducing the risk of injury from running.

The memory request router 58 routes the memory request 54 to the health memory retrieval agent 28a, which is coupled to a health memory bank 26a containing health information about the user, and the fitness memory retrieval agent 28b, which is coupled to a fitness memory bank 26b containing fitness-related information about the user. The health memory retrieval agent 28a executes request handling logic and forwards the request to the relevance evaluator to determine whether or not to proceed with processing the memory request 54. Upon determining to proceed with the memory request 54, the health memory retrieval agent 28a vectorizes the context 46 of the memory request 54, and computes distances between the vector representations associated with the stored memories in the health memory bank 26a and the vector representation of the context 46 of the memory request 54. The health memory retrieval agent 28a then retrieves a relevant memory 48a (“The user has a history of ACL tear.”) based on a predetermined distance threshold and the computed distances.

Likewise, the fitness memory retrieval agent 28b executes request handling logic and forwards the request to the relevance evaluator to determine whether or not to proceed with processing the memory request 54. Upon determining to proceed with the memory request 54, the fitness memory retrieval agent 28b vectorizes the context 46 of the memory request 54, and computes distances between the vector representations associated with the stored memories in the fitness memory bank 26b and the vector representation of the context 46 of the memory request 54. The fitness memory retrieval agent 28b then retrieves a relevant memory 48b (“The user has expressed concerns about reducing high-impact exercises. The user has expressed interest in strength training.”) based on a predetermined distance threshold and the computed distances.

The memory request router 58 generates a memory response 56 containing the relevant memories 48a, 48b and outputs the memory response 56 to the answer service, which uses the memory response to generate a prompt to be inputted into the trained generative model.

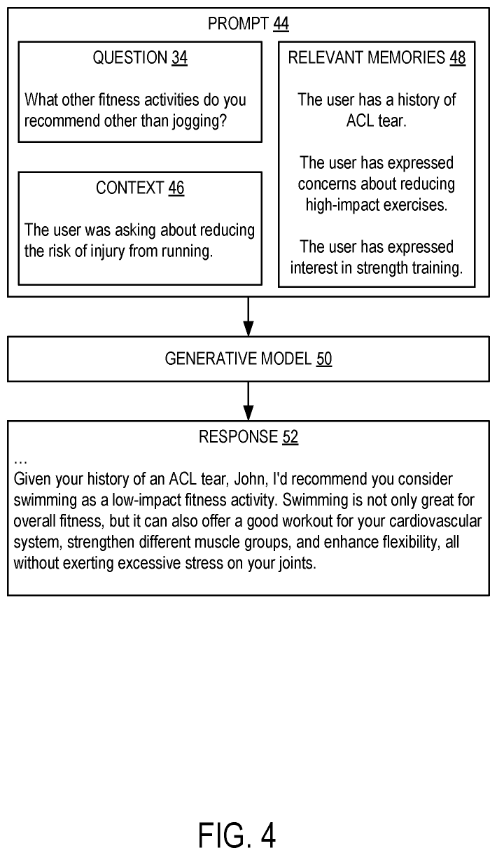

Turning to FIG. 4, an example is described of an inputted prompt 44 which is inputted into the generative model 50 to output a response 52. In this example, the relevant memories 48 retrieved by the memory request router 58 of FIG. 3 is incorporated into a prompt 44 that is generated by the answer service 42 of FIGS. 1 and 2. The prompt 44 generated by the answer service 42 also includes the question 34 from the user as well as the context 46 of the question as shown in the example of FIG. 3. The generated response 52 addresses the question 34 from the user about other fitness activities other than jogging to pursue, and takes into consideration the retrieved relevant memories 48 of the user, which include the facts that the user has a history of ACL tear, the user has expressed concerns about reducing high-impact exercises, and the user has expressed interest in strength training. The generated response 52 includes a recommendation to consider swimming as a low-impact fitness activity that can strengthen different muscle groups without exerting excessive stress on the user's joints.

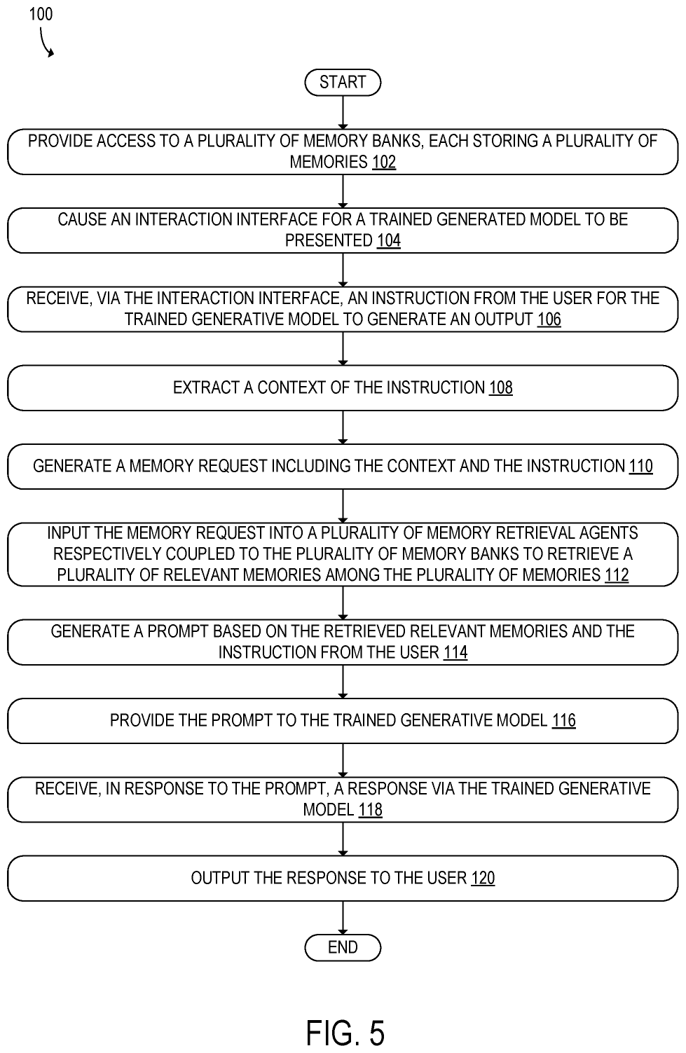

FIG. 5 shows a flowchart for a first method 100 for selective memory retrieval according to one example implementation. The first method 100 may be implemented by the computing system 10A or 10B illustrated in FIGS. 1 and 2, respectively.

At step 102, access to a plurality of memory banks, each storing a plurality of memories, is provided. At step 104, an interaction interface for a trained generative model is caused to be presented. At step 106, an instruction is received from the user, via the interaction interface, for the trained generative model to generate an output. At step 108, a context of the instruction is extracted. At step 110, a memory request is generated including the context and the instruction. At step 112, the memory request is inputted into a plurality of memory retrieval agents respectively coupled to the plurality of memory banks to retrieve a plurality of relevant memories among the plurality of memories.

At step 114, a prompt is generated based on the retrieved relevant memories and the instruction from the user. At step 116, the prompt is provided to the trained generative model. At step 118, in response to the prompt, a response is received from the trained generative model. At step 120, the response is outputted to the user.

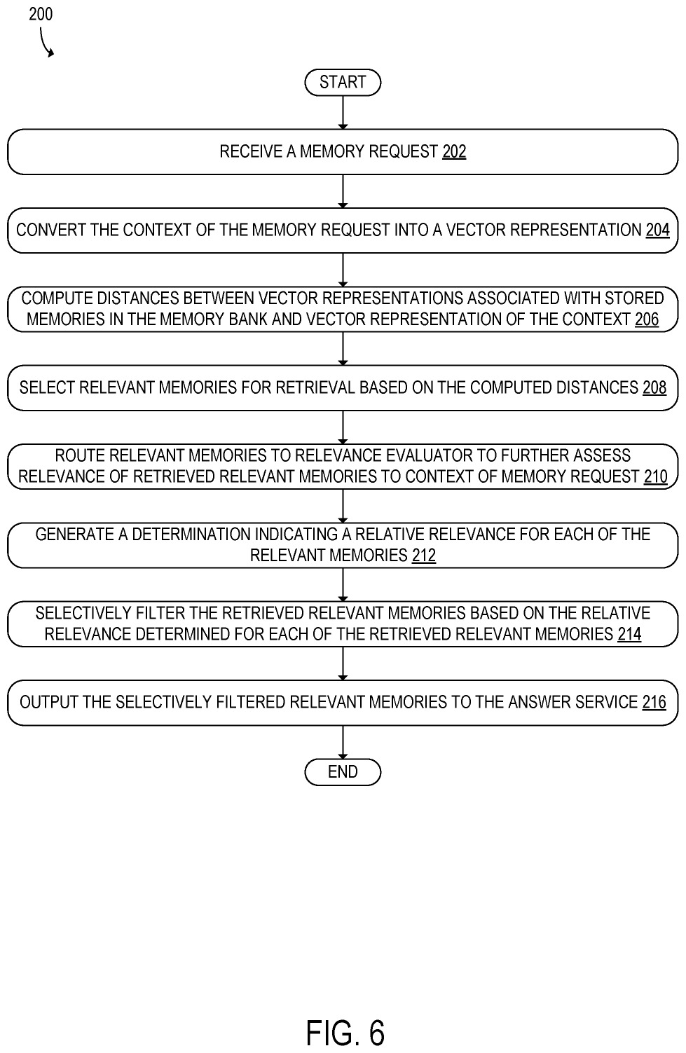

FIG. 6 shows a flowchart for a second method 200 for selective memory retrieval according to one example implementation. The second method 200 may be implemented by the memory retrieval agents 28 and relevance evaluator 62 illustrated in FIGS. 1 and 2, respectively.

At step 202, a memory request is received by the memory retrieval agent. At step 204, the context of the memory request is converted into a vector representation. At step 206, distances between the vector representations associated with the stored memories in the memory bank and the vector representation of the context are computed.

At step 208, relevant memories are selected for retrieval based on the computed distances. At step 210, the relevant memories are routed to a relevance evaluator to further assess the relevance of the retrieved relevant memories to the context of the memory request. At step 212, a determination is generated indicating a relative relevance for each of the relevant memories. At step 214, the retrieved relevant memories are selectively filtered based on the relative relevance determined for each of the retrieved relevant memories. At step 216, the selectively filtered relevant memories are outputted to the answer service.

The above-described systems and method are capable of not only storing memories from user interactions into memory banks, but also intelligently retrieving relevant memories from the memory banks in a targeted manner for incorporating into prompts to input into generative models to answer questions or fulfill inquiries from a user in a personalized and contextually appropriate fashion.

In some embodiments, the methods and processes described herein may be tied to a computing system of one or more computing devices. In particular, such methods and processes may be implemented as a computer-application program or service, an API, a library, and/or other computer-program product.

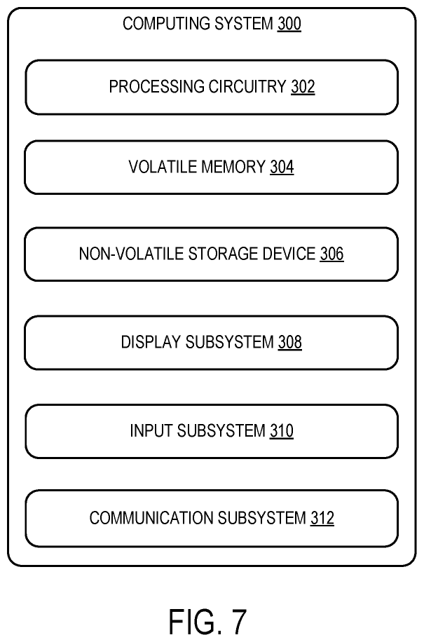

FIG. 7 schematically shows a non-limiting embodiment of a computing system 300 that can enact one or more of the methods and processes described above. Computing system 300 is shown in simplified form. Computing system 300 may embody the computing systems 10A and 10B described above and illustrated in FIGS. 1 and 2, respectively. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes processing circuitry 302, volatile memory 304, and a non-volatile storage device 306. Computing system 300 may optionally include a display subsystem 308, input subsystem 310, communication subsystem 312, and/or other components not shown in FIG. 7.

Processing circuitry typically includes one or more logic processors, which are physical devices configured to execute instructions. For example, the logic processors may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the processing circuitry 302 may be single-core or multi-core, and the instructions executed thereon may be configured for sequential, parallel, and/or distributed processing. Individual components of the processing circuitry optionally may be distributed among two or more separate devices, which may be remotely located and/or configured for coordinated processing. For example, aspects of the computing system disclosed herein may be virtualized and executed by remotely accessible, networked computing devices configured in a cloud-computing configuration. In such a case, these virtualized aspects are run on different physical logic processors of various different machines, it will be understood. These different physical logic processors of the different machines will be understood to be collectively encompassed by processing circuitry 302.

Non-volatile storage device 306 includes one or more physical devices configured to hold instructions executable by the processing circuitry to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by processing circuitry 302 to temporarily store information during processing of software instructions. It will be appreciated that volatile memory 304 typically does not continue to store instructions when power is cut to the volatile memory 304.

Aspects of processing circuitry 302, volatile memory 304, and non-volatile storage device 306 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via processing circuitry 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a GUI. As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with processing circuitry 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 300 to send and/or receive messages to and/or from other devices via a network such as the Internet.

The following paragraphs additionally describe aspects of the subject application. One aspect provides a computing system for selective memory retrieval, comprising processing circuitry configured to provide access to a plurality of memory banks each storing a plurality of memories, cause an interaction interface for a trained generative model to be presented, receive, via the interaction interface, an instruction from a user for the trained generative model to generate an output, extract a context of the instruction, generate a memory request including the context and the instruction, input the memory request into a plurality of memory retrieval agents respectively coupled to the plurality of memory banks to retrieve a plurality of relevant memories among the plurality of memories, generate a prompt based on the retrieved relevant memories and the instruction from the user, provide the prompt to the trained generative model, receive, in response to the prompt, a response from the trained generative model, and output the response to the user. In this aspect, additionally or alternatively, the trained generative model may be a trained generative language model. In this aspect, additionally or alternatively, the trained generative language model may be a generative pre-trained transformer model. In this aspect, additionally or alternatively, the instruction may be divided into a plurality of instructions, and the plurality of instructions may be incorporated into a plurality of memory requests, respectively, and inputted into the plurality of memory retrieval agents. In this aspect, additionally or alternatively, the plurality of memory retrieval agents may convert the plurality of memories into vector representations. In this aspect, additionally or alternatively, a given memory retrieval agent among the plurality of memory retrieval agents may compute distances between the vector representations and a vector representation of the context to retrieve the plurality of relevant memories among memories of a respective memory bank of the given memory retrieval agent. In this aspect, additionally or alternatively, the plurality of relevant memories may be selected for retrieval based on a predetermined distance threshold. In this aspect, additionally or alternatively, the vector representations are stored in a database supporting vector search. In this aspect, additionally or alternatively, the plurality of relevant memories may be inputted into a relevance evaluator to determine a relative relevance for each of the plurality of relevant memories, and the plurality of relevant memories may be selectively filtered based on the relative relevance determined for each of the plurality of relevant memories. In this aspect, additionally or alternatively, the relevance evaluator may be a generative model or a classifier.

Another aspect provides a method for selective memory retrieval, comprising providing access to a plurality of memory banks, each memory bank storing a plurality of memories, causing an interaction interface for a trained generative model to be presented, receiving, via the interaction interface, an instruction from a user for the trained generative model to generate an output, extracting a context of the instruction, generating a memory request including the context and the instruction, inputting the memory request into a plurality of memory retrieval agents respectively coupled to the plurality of memory banks to retrieve a plurality of relevant memories among the plurality of memories, generating a prompt based on the retrieved relevant memories and the instruction from the user, providing the prompt to the trained generative model, receiving, in response to the prompt, a response from the trained generative model, and outputting the response to the user. In this aspect, additionally or alternatively, the trained generative model may be a trained generative language model. In this aspect, additionally or alternatively, the trained generative language model may be a generative pre-trained transformer model. In this aspect, additionally or alternatively, the instruction may be divided into a plurality of instructions, and the plurality of instructions may be incorporated into a plurality of memory requests, respectively, and inputted into the plurality of memory retrieval agents. In this aspect, additionally or alternatively, the plurality of memory retrieval agents may convert the plurality of memories of the plurality of memory banks into vector representations. In this aspect, additionally or alternatively, a given memory retrieval agent among the plurality of memory retrieval agents may compute distances between the vector representations and a vector representation of the context to retrieve the plurality of relevant memories among memories of a respective memory bank of the given memory retrieval agent. In this aspect, additionally or alternatively, the plurality of relevant memories may be selected for retrieval based on a predetermined distance threshold. In this aspect, additionally or alternatively, the vector representations may be stored in a database supporting vector search. In this aspect, additionally or alternatively, the plurality of relevant memories may be inputted into a relevance evaluator to determine a relative relevance for each of the plurality of relevant memories, and the plurality of relevant memories may be selectively filtered based on the relative relevance determined for each of the plurality of relevant memories.

Another aspect provides a computing system for selective memory retrieval, comprising processing circuitry configured to provide access to a plurality of memory banks each storing a plurality of memories, cause an interaction interface for a trained generative model to be presented, receive, via the interaction interface, an instruction from a user for the trained generative model to generate an output, extract a context of the instruction, generate a memory request including the context and the instruction, input the memory request into a plurality of memory retrieval agents respectively coupled to the plurality of memory banks to retrieve a plurality of relevant memories among the plurality of memories, generate a prompt based on the retrieved relevant memories and the instruction from the user, invoke an application programming interface call to transmit the prompt to the trained generative model that receives input of the prompt including natural language text input and, in response, generates a response that includes natural language text output, receive, in response to the prompt, the response from the trained generative model, and output the response to the user.

“And/or” as used herein is defined as the inclusive or ∨, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing system for selective memory retrieval, comprising:
processing circuitry configured to:
provide access to a plurality of memory banks, each storing a plurality of memories;
cause an interaction interface for a trained generative model to be presented;
receive, via the interaction interface, an instruction from a user for the trained generative model to generate an output;
extract a context of the instruction;
generate a memory request including the context and the instruction;
input the memory request into a plurality of memory retrieval agents respectively coupled to the plurality of memory banks to retrieve a plurality of relevant memories among the plurality of memories;
generate a prompt based on the retrieved relevant memories and the instruction from the user;
provide the prompt to the trained generative model;
receive, in response to the prompt, a response from the trained generative model; and
output the response to the user.

2. The computing system of claim 1, wherein the trained generative model is a trained generative language model.

3. The computing system of claim 2, wherein the trained generative language model is a generative pre-trained transformer model.

4. The computing system of claim 1, wherein
the instruction is divided into a plurality of instructions; and
the plurality of instructions are incorporated into a plurality of memory requests, respectively, and inputted into the plurality of memory retrieval agents.

5. The computing system of claim 1, wherein the plurality of memory retrieval agents convert the plurality of memories into vector representations.

6. The computing system of claim 5, wherein
a given memory retrieval agent among the plurality of memory retrieval agents computes distances between the vector representations and a vector representation of the context to retrieve the plurality of relevant memories among memories of a respective memory bank of the given memory retrieval agent.

7. The computing system of claim 6, wherein the plurality of relevant memories are selected for retrieval based on a predetermined distance threshold.

8. The computing system of claim 5, wherein the vector representations are stored in a database supporting vector search.

9. The computing system of claim 1, wherein
the plurality of relevant memories are inputted into a relevance evaluator to determine a relative relevance for each of the plurality of relevant memories; and
the plurality of relevant memories are selectively filtered based on the relative relevance determined for each of the plurality of relevant memories.

10. The computing system of claim 9, wherein
the relevance evaluator is a generative model or a classifier.

11. A method for selective memory retrieval, comprising:
providing access to a plurality of memory banks, each storing a plurality of memories;
causing an interaction interface for a trained generative model to be presented;
receiving, via the interaction interface, an instruction from a user for the trained generative model to generate an output;
extracting a context of the instruction;
generating a memory request including the context and the instruction;
inputting the memory request into a plurality of memory retrieval agents respectively coupled to the plurality of memory banks to retrieve a plurality of relevant memories among the plurality of memories;
generating a prompt based on the retrieved relevant memories and the instruction from the user;
providing the prompt to the trained generative model;
receiving, in response to the prompt, a response from the trained generative model; and
outputting the response to the user.

12. The method of claim 11, wherein the trained generative model is a trained generative language model.

13. The method of claim 12, wherein the trained generative language model is a generative pre-trained transformer model.

14. The method of claim 11, wherein
the instruction is divided into a plurality of instructions; and
the plurality of instructions are incorporated into a plurality of memory requests, respectively, and inputted into the plurality of memory retrieval agents.

15. The method of claim 11, wherein the plurality of memory retrieval agents convert the plurality of memories of the plurality of memory banks into vector representations.

16. The method of claim 15, wherein
a given memory retrieval agent among the plurality of memory retrieval agents computes distances between the vector representations and a vector representation of the context to retrieve the plurality of relevant memories among memories of a respective memory bank of the given memory retrieval agent.

17. The method of claim 16, wherein the plurality of relevant memories are selected for retrieval based on a predetermined distance threshold.

18. The method of claim 15, wherein the vector representations are stored in a database supporting vector search.

19. The method of claim 11, wherein
the plurality of relevant memories are inputted into a relevance evaluator to determine a relative relevance for each of the plurality of relevant memories; and
the plurality of relevant memories are selectively filtered based on the relative relevance determined for each of the plurality of relevant memories.

20. A computing system for selective memory retrieval, comprising:
processing circuitry configured to:
provide access to a plurality of memory banks, each storing a plurality of memories;
cause an interaction interface for a trained generative model to be presented;
receive, via the interaction interface, an instruction from a user for the trained generative model to generate an output;
extract a context of the instruction;
generate a memory request including the context and the instruction;
input the memory request into a plurality of memory retrieval agents respectively coupled to the plurality of memory banks to retrieve a plurality of relevant memories among the plurality of memories;
generate a prompt based on the retrieved relevant memories and the instruction from the user;
invoke an application programming interface (API) call to transmit the prompt to the trained generative model that receives input of the prompt including natural language text input and, in response, generates a response that includes natural language text output;
receive, in response to the prompt, the response from the trained generative model; and
output the response to the user.
